(19) United States
(12) Patent Application Publication
(10) Pub. No.: US 2026/0337004 A1
(43) Pub. Date: Oct. 29, 2026

(54) BRIXING SCREWS FOR POST-MIX BEVERAGE DISPENSING TAP VALVE

(71) Applicant: Michael Curci, Annandale, NJ (US)

(72) Inventor: Michael Curci, Annandale, NJ (US)

(21) Appl. No.: 19/735,320

(22) Filed: Jul. 8, 2026

Related U.S. Application Data
(63) Continuation-in-part of application No. 18/800,433, filed on Aug. 12, 2024.
Application No. 18/800,433 is a continuation of application No. 18/446,421, filed on Aug. 8, 2023, now Pat. No. 12,060,257.
Application No. 18/446,421 is a continuation of application No. 17/656,775, filed on Mar. 28, 2022, now Pat. No. 11,760,621.

(51) Int. Cl. B67D 1/14; B67D 1/00

(52) U.S. Cl. CPC B67D 1/1438; B67D 1/0021

(57) ABSTRACT

A post-mix beverage dispensing tap valve to dispense a beverage into a vessel. A connection and mounting assembly mounts the post-mix beverage dispensing valve a wall and connecting with a source of a beverage product and a source of water. A drafting head is formed as an elongate cylindrical body with an internal bore. A piston shaft is operable by a tap actuator to selectively block and permit a flow of the beverage syrup and the water through the internal bores. The piston shaft carries a seal and a spring. The seal abuts and seal with the facet to prevent flow through the internal bores. A brixing screw is provided in each of a first flow path and second path to at least partially obstruct the flow paths to obtain a desired mixture ratio of the beverage product. A method of adjusting the desired beverage mixture ratio is also provided.

### CROSS-REFERENCE TO RELATED APPLICATION

This application is a continuation in part of U.S. patent application Ser. No. 118/800,433, filed Aug. 12, 2024, which is a continuation of U.S. patent application Ser. No. 18/446421, filed Aug. 8, 2023, issued Aug. 13, 2024 as U.S. Pat. No. 12,060,257 and claims the benefit of priority of U.S. patent application Ser. No. 17/656,775 filed Mar. 28, 2022 and issued as U.S. Pat. No. 11,760,621, Sep. 19, 2023, the contents of which are herein incorporated by reference.

### BACKGROUND OF THE INVENTION

The present invention relates to beverage dispensing valves, and more particularly to post-mix beverage dispensing valves, commonly referred to as taps.

Draft style taps are well known in the art. However, most current draft style soda taps are intended for pre-mix beverages. That is, they only dispense single liquid product beverages such as beer, wine, or juices.

Post-mix tap valves dispense a beverage syrup, such as a soda or juice, in a first stream with water dispensed in a second stream. The water may be carbonated or uncarbonated, depending upon the type of beverage being mixed. The first stream and the second streams are mixed external of the tap as they are dispensed into a vessel, such as a cup or a pitcher. The other post-mix tap valves in the field have seals that scrape and rub in the inner walls and cause fast wear and leaks.

The post-mix beverage dispensing valves are typically utilized in a restaurant setting, where beverages may be served by a restaurant worker, or by a customer in a self-serve beverage area of the restaurant.

In either instance, the leaks can present a safety hazard to either the restaurant worker or the customer, by making the floor about the dispenser wet. Likewise, the leaks represent a waste of product, an unsightly beverage dispensing area, cleanup, repair, and denial of a selected beverage product to customers while the defective tap is repaired.

Brixing is a process by which the ratio of the beverage syrup to the water is set for the post-mix tap valve to dispense the mixed beverage according to a manufacturer's specification. Other post-mix tap valves in the industry require frequent adjustment by a technician otherwise the mixture can become overly dilute or overly concentrated, leading to customer dissatisfaction with their beverage and associated wasted product.

As can be seen, there is a need for improved brixing for post-mix soda dispensing tap valves that solve these problems.

### SUMMARY OF THE INVENTION

In one aspect of the present invention, a dispensing valve for post-mix dispensing of a beverage syrup and a source of water is disclosed. The dispensing valve includes a drafting head formed as an elongate cylindrical body having proximal end and a distal end. A bore for each of a beverage syrup and the source of water extends between the proximal end and the distal end. A proximal end of each bore has a facet oriented in the bore towards the proximal end. A piston shaft is received through each bore.

In some embodiments, the post-mix dispensing tap valve for dispensing of a first liquid and a second liquid at a desired mixture ratio, is disclosed. The post-mix dispensing tap valve includes a head formed as an elongate cylindrical body having proximal end and a distal end. The elongate cylindrical body includes a first bore for communicating the first liquid through the head and a second bore for communicating the second liquid through the head. A nozzle and diffuser assembly is disposed at the distal end of the head and has a first liquid path in communication with the first bore and a second liquid path in communication with the second bore. The nozzle is configured to dispense the first liquid and the second liquid into a containment vessel positioned below the nozzle and diffuser assembly.

A first brixing bore is defined in the an outer sidewall of the elongate cylindrical body and intersects the first fluid path. A first brixing screw is adjustably carried within the first brixing bore to selectively position a distal end of the first brixing screw to at least partially obstruct the flow of the first fluid through the first fluid path.

A second brixing bore is also defined in the outer sidewall of the elongate cylindrical body and intersects with the second fluid path. A second brixing screw is adjustably carried within the second brixing bore to selectively position a distal end of the second brixing screw to at least partially obstruct flow of the second fluid through the second fluid path. An adjustment of each of the first brixing screw and the second brixing screw sets the desired mixture ratio of each of the first liquid and the second liquid.

In some aspects of the invention, an O-ring is carried on each of the first brixing screw and the second brixing screw. Each O-ring provides a fluid tight seal between the outer sidewall of each of the respective first brixing bore and the second brixing bore and the corresponding first fluid path and the second fluid path.

In some aspects, a plurality of threads defined on an outer end of each of the first brixing screw and the second brixing screw. A corresponding plurality of threads are defined in each of the first brixing bore and the second brixing bore. Rotation of each of the first brixing screw and the second brixing screw within its corresponding first brixing bore and second brixing bore are used to selectively advance or withdraw each of the first brixing screw and the second brixing screw from its corresponding first flow path and second flow path.

In some aspects, a locking nut is threadingly carried on each of the first brixing screw and the second brixing screw. The locking nuts are adapted to secure each of the first brixing screw and the second brixing screw at the desired mixture ratio.

In certain aspects of the invention, the post-mix dispensing tap valve includes a first lateral bore extending between the first bore and a peripheral fluid path in communication with a diffuser surrounding the nozzle. The he second fluid path may include a dispenser port interposed between the second bore and the nozzle. In this event, the second brixing screw is selectively positioned to at least partially obstruct the dispenser port at the desired mixture ratio. A plug may be disposed in the second lateral bore proximal to the outer sidewall. Likewise, a plug may disposed in the second lateral bore proximal to the outer sidewall.

In yet other aspects of the invention, a tap actuator unit selectively operates a piston shaft in each of the first bore and the second bore to simultaneously operate a seal carried on each piston between a flow and no-flow condition.

In certain embodiments, the nozzle and diffuser assembly is removably coupled with the tap head via a threaded coupling with a dispenser port interposed between the second bore and the nozzle. The nozzle and diffuser assembly may also include a peripheral fluid path surrounding the nozzle.

In another aspect of the invention, a method of dispensing a post-mix beverage at a desired mixture ratio is disclosed. The method includes providing a post-mix dispensing tap valve having a head formed as an elongate cylindrical body having proximal end and a distal end. The elongate cylindrical body includes a first bore for communicating the first liquid through the head. A second bore for communicating the second liquid through the head is also provided. A nozzle and diffuser assembly is disposed at the distal end of the head having a first liquid path in communication with the first bore.

A second liquid path is defined in communication with the second bore. The nozzle is configured to dispense the first liquid and the second liquid on activation of a tap actuator unit. The tap actuator unit is operable to simultaneously operate a valve in each of the first bore and the second bore to selectively open or close a flow in each of the first liquid path and the second liquid path.

A first brixing screw is adjustably carried within a first brixing bore to selectively position a distal end of the first brixing screw to at least partially obstruct the flow of the first fluid through the first fluid path. A second brixing screw is adjustably carried within a second brixing bore to selectively position a distal end of the second brixing screw to at least partially obstruct flow of the second fluid through the second fluid path.

The method includes dispensing the first liquid through the nozzle and diffuser assembly while blocking a flow of the second liquid trough the post-mix dispensing tap valve. The dispensed first liquid is captured in a containment vessel. A flow rate of the first liquid is determined based on a volume of the first liquid captured in the containment vessel during a first temporal period.

The method ma also include dispensing the second liquid through the nozzle and diffuser assembly while blocking a flow of the first liquid through the post-mix dispensing tap valve. The dispensed second liquid is similarly captured in the containment vessel. A flow rate of the second liquid is determined based on a volume of the second liquid captured in the containment vessel during a second temporal period.

In certain embodiments, the method includes determining a present mixture ratio of the first liquid and the second liquid based on the flow rate of the first liquid and the flow rate of the second liquid. Likewise, rotating the first brixing screw may be performed to vary the flow rate of the first liquid to obtain a desired mixture ratio based on the present mixture ratio. Once obtained, the method includes tightening a locknut on the first brixing screw to secure the first brixing screw at the desired mixture ratio.

In some embodiments, the method includes rotating the second brixing screw to vary the flow rate of the second liquid in order to obtain a desired mixture ratio based the present mixture ratio. Once obtained, the method includes tightening a locknut on the second brixing screw to secure the second brixing screw at the desired mixture ratio.

These and other features, aspects and advantages of the present invention will become better understood with reference to the following drawings, description and claims.

### BRIEF DESCRIPTION OF THE DRAWINGS

FIG. 1 is a front perspective view of a post-mix beverage dispensing tap valve with brixing screws installed.

FIG. 2 is a front perspective view of the post-mix beverage dispensing tap valve showing the brixing screws in an exploded condition.

FIG. 3 is a side elevation view of the post-mix beverage dispensing tap valve.

FIG. 4 is a partial front elevation view at a front face of the post-mix beverage dispensing tap valve.

FIG. 5 is an exploded perspective view of the post-mix beverage dispensing tap valve.

FIG. 6 is a cross-sectional view, taken along line 6-6 of FIG. 1.

FIG. 7 is a cross-sectional view taken on line 7-7 of FIG. 2.

FIG. 8 is a cross-sectional view taken on line 8-8 of FIG. 3.

FIG. 9 is an exploded cross-sectional view of FIG. 8.

FIG. 10 is a cross-sectional view taken on line 10-10 of FIG. 3.

FIG. 11 is an exploded cross-sectional view of FIG. 10.

### DETAILED DESCRIPTION

The following detailed description is of the best currently contemplated modes of carrying out exemplary embodiments of the invention. The description is not to be taken in a limiting sense but is made merely for the purpose of illustrating the general principles of the invention.

Broadly, embodiments of the present invention provide a post-mix beverage dispensing tap valve that provides an improved adjustment mechanism for setting a mix ratio of a beverage syrup and an associated diluent water source, whether that diluent source is carbonated or not. Once set, the brixing screws do not require additional adjustment until the desired mixing ratio of the beverage syrup and the diluent water source are changed. This feature significantly reduces the beverage station servicing technician's time when servicing the beverage station, preserves beverage syrup, and reduces the spillage from failed or defective brixing components in current post-mix soda dispensing tap valves in the art.

Other embodiments of the invention include a method of setting/adjusting the mix ratio of the post-mix soda dispensing tap valve. Yet other embodiments of the invention include a method of manufacturing the post-mix beverage dispensing tap valve with brixing mechanism.

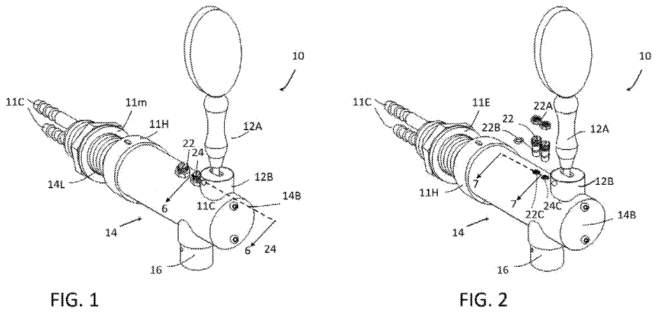

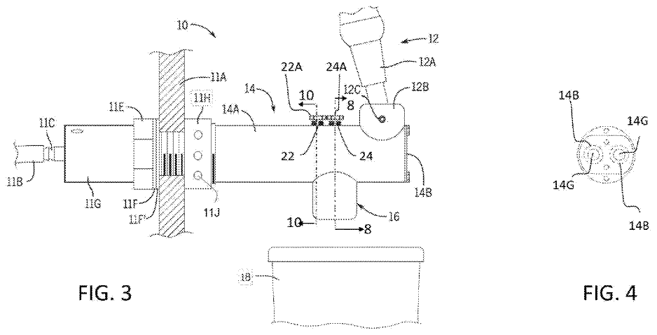

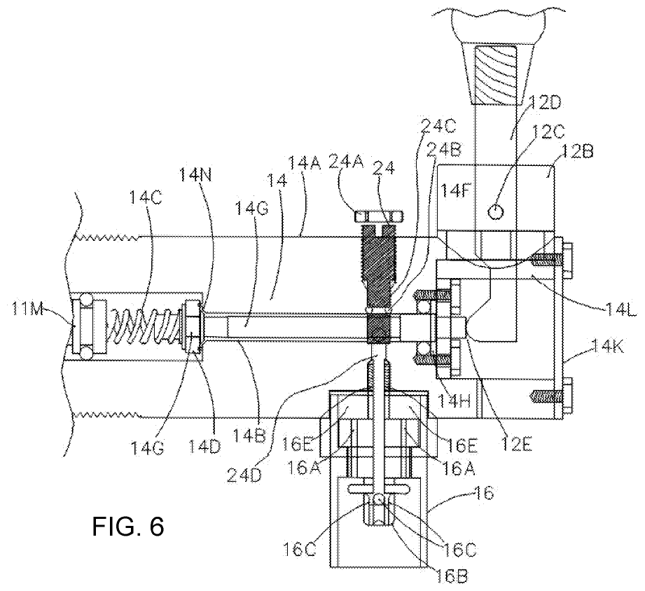

A representative post-mix beverage dispensing tap valve 10 according to aspects of the invention is shown in the drawings of FIG. 1-11. As seen in reference to FIG. 3, the post-mix beverage dispensing tap valve 10 is adapted to be mounted to a wall 11A, or other vertical support structure. The post-mix beverage dispensing tap valve 10 includes a connection and mounting assembly 11 at a rear end, a tap actuator unit 12 at a front end, a drafting head 14; and a nozzle and diffuser assembly 16. The post-mix beverage dispensing tap valve 10 is configured to dispense a post-mixed beverage into a containment vessel 18, such as a cup or a pitcher.

The connection and mounting assembly 11 is configured for mounting the post-mix beverage dispensing tap valve 10 to the wall 11A and connecting the post-mix beverage dispensing tap valve 10 with each of a source of a beverage product and a source of a diluent, such as water.

A source tube 11B carries each of the source of the beverage product and the source of water and is operatively connected to the post-mix beverage dispensing tap valve 10 at a hose barb of a corresponding source conduit 11C extending from a back end of the connection and mounting assembly 11. The source conduits 11C are carried through an interior of a mounting shank 11D to a forward end of the mounting shank 11D.

The mounting shank 11D includes a plurality of threads for engagement with a mounting nut 11E. One or more washers 11F, 11F′ may be provided for carriage on the mounting shank 11D. A rear collar 11G may be applied to retain the nut 11E in position on the mounting shank 11D. The rear collar may be secured to the mounting shank 11D via one or more set screws 17 received in an aperture on the mounting shank 11D.

A mount collar 11H may be provided at a forward end of the mounting shank 11D. The mount collar 11H is retained by an annular rim 11J at a forward end of the mounting shank 11D. The mount collar 11H provides a recess 11K in which a front end of the source conduits 11C terminate. The mount collar 11H has a plurality of threads 11L for coupling with a corresponding plurality of threads 14L disposed on an aft end of the drafting head 14. A washer, or O-ring 11M is provided about the front end of the source conduits 11C to provide a liquid tight fitting between a coupling 11N at a front end the source conduit 11C and a pair of internal bores 14B, 14B′ defined in an aft end of the drafting head 14. The coupling 11N at the front end of the source conduits 11C may be provided by one or more of a threaded coupling, a press fit coupling, or a welded coupling with the mounting shank 11D.

The mounting assembly 11 is coupled to the wall 11A by passing the aft end of the mounting shank 11D through a hole in the wall 11A. An aft surface of the mount collar 11H has an outer diameter that is greater than the diameter of the hole in the wall 11A and provides a front retainer against a first surface of the wall 11A. The nut 11E, and any accompanying washers 11F, 11F′ are then threaded along an aft end of the mounting shank 11D to tighten against an opposite second surface of the wall 11A.

The drafting head 14 is formed as an elongate cylindrical body 14A having a pair of internal bores 14B, 14B′ that extend between a proximal end and a distal end of the cylindrical body 14A for each of the beverage source and the diluent source. An inner diameter of the proximal end of each internal bore 14B, 14B′ is dimensioned for a liquid tight coupling with O-rings 11M surrounding the coupling 11N. The proximal end of the internal bores 14B, 14B′ are formed with a facet 14N oriented to an inlet of the internal bore 14B, 14B′. Preferably, the facet 14N is shouldered.

A piston shaft 14G has a proximal end, oriented towards the mounting shank 11D, and a distal end, oriented towards the nozzle and diffuser assembly 16. The piston shaft 14G is operable by the tap actuator unit 12 to selectively operate a seal 14D to block or permit a flow of each of the beverage syrup and the diluent water through their respective internal bores 14B, 14B′. The tap actuator unit 12 operates each piston shaft 14G simultaneously to selectively operate each seal 14D between a flow and no-flow condition.

A proximal end of the piston shaft 14G carries the seal 14D and a spring 14C. The seal 14D is dimensioned to abut and seal with the facet 14N to prevent flow of the beverage syrup and the diluent water through their respective internal bores 14B, 14B′.

A distal end of the spring 14C may be retained on a proximal end of the piston shaft 14G via a radial compression about the shaft of the piston shaft 14G. This joining of the spring 14C with the piston shaft 14G retains the seal 14D on the piston shaft 14G. The retention of the spring 14C on the piston shaft 14G facilitates assembly and disassembly of the piston shaft 14G, the seal 14D, and the spring 14C with the drafting head 14. A proximal end of the spring 14C abuts with a distal end of the coupling 11N. The spring 14C biases the piston shaft 14G and urges the seal 14D in abutment with the facet 14N when the drafting head 14 is coupled with the mounting shank 11D.

A distal end of the drafting head 14 is configured with plunger retainer 14F. The plunger retainer 14F has an aperture 14F′ for each piston shaft 14G, such that a distal end of each piston shaft 14G extends beyond the distal end of the drafting head 14. The aperture 14F′ is dimensioned to receive a distal end of the piston shaft 14G. A seal 14H is provided for sealing about the piston shaft 14G and the distal end of internal bores 14B, 14B′ by compression of the plunger retainer 14F against the seal 14H and a sealing fit of the seal 14H about the diameter of the piston shaft 14G. The plunger retainer 14F may be secured to the elongate cylindrical body 14A by a fastener, such as a screw.

The tap actuator unit 12 is coupled with a tap actuator unit aperture 14P defined through a top surface of the elongate cylindrical body 14A at the distal end of the elongate cylindrical body 14A. The tap actuator unit 12 includes a tap handle 12A, a head cap 12B, a pivot pin 12C, a pivot fork 12D and a collar 12F. The tap handle 12A is coupled with the pivot fork 12D which is pivotally actuated about the pivot pin 12C in a fore and an aft direction. Actuation of the tap handle 12A selectively operates each of seals 14D on the piston shafts 14G between a flow and a no-flow position.

The pivot fork 12D has a pair of downwardly oriented fork arms 12E that are receive through the tap actuator unit aperture 14P to engage with the distal ends of the piston shafts 14G. The pivot fork 12D is pivotally carried on the pivot pin 12C, which is coupled with the head cap 12B. The collar 12F closes the tap actuator unit aperture 14P when positioned between the head cap 12B and the elongate cylindrical body 14A. The pivot fork 12D includes a tap shaft 12G that extends through a slotted aperture in the head cap 12B for attachment of the tap handle 12A. A cover plate 14K is attached to a front face of the drafting head 14 to contain the fork arms 12E and distal ends of the piston shafts 14G.

When actuated by the tap handle 12A, the fork arms 12E simultaneously actuate the piston shafts 14G to open the seal 14D from the facet 14N and permit flow of the beverage syrup and the diluent water source through their respective internal bores 14B, 14B′. The flow of each of the beverage syrup and diluent water source is carried through the internal bores 14B, 14B′ and delivered to the nozzle and diffuser assembly 16 via a corresponding first fluid path and a second fluid path and initially mixed within the nozzle and diffuser assembly 16.

A first brixing screw 22 is received in a first brixing bore 22C that is defined in the elongate cylindrical body 14A. The first brixing screw 22 carries an O-ring 22B to provide a fluid tight seal between an outer end of the first brixing screw 22 and a first fluid path defined between a first of the pair of internal bores 14B and a peripheral fluid path contained within a top end of the nozzle and diffuser assembly 16. The first fluid path may include a first lateral bore 22F that is in fluid communication with the first of the pair of internal bores 14B and a terminal fluid path 22D that terminates with the peripheral fluid path.

The first brixing screw 22 has a plurality of threads defined on an outer end of the first brixing screw 22 that engage with a corresponding plurality of threads defined at an outer end of the first brixing bore 22C. The first brixing screw 22 may be adjusted within the first brixing bore 22C to advance or retract the first brixing screw 22 within the first brixing bore 22C by cooperative engagement of the threads during rotation of the first brixing screw 22.

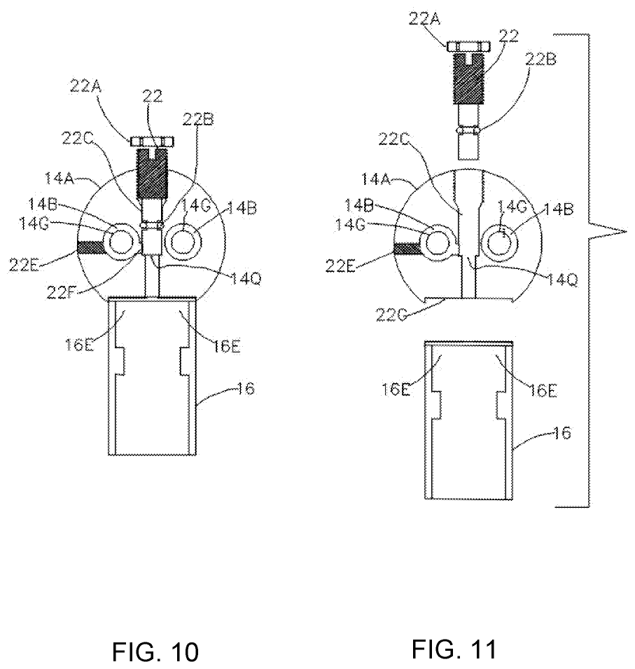

Rotation of the first brixing screw 22 adjusts the flow of the fluid carried in the first by selectively positioning a distal end of the first brixing screw to obstruct, at least partially, the flow of the first fluid, typically the diluent fluid, through the first fluid path. In the embodiment shown in reference to FIGS. 10 and 11, the first brixing screw 22 is interposed into the first lateral bore 22F to obstruct the flow of the diluent fluid into the peripheral fluid path 16E for mixing with the beverage syrup in the nozzle and diffuser assembly 16. As will be appreciated, in other arrangements, the first brixing screw 22 may be positioned anywhere along the first fluid path to at least partially obstruct and regulate the flow of the diluent into the nozzle and diffuser assembly 16.

A second brixing screw 24 is received in a second brixing bore 24C that is defined in the elongate cylindrical body 14A. The second brixing screw 24 carries a seal, such as an O-ring 24B to provide a fluid tight seal between an outer end of the second brixing screw 24 and a second fluid path defined between the second of the pair of internal bores 14B′ and a dispenser port 14Q defined in a bottom surface of the drafting head 14 at the distal end of the second of the pair of internal bores 14B′.

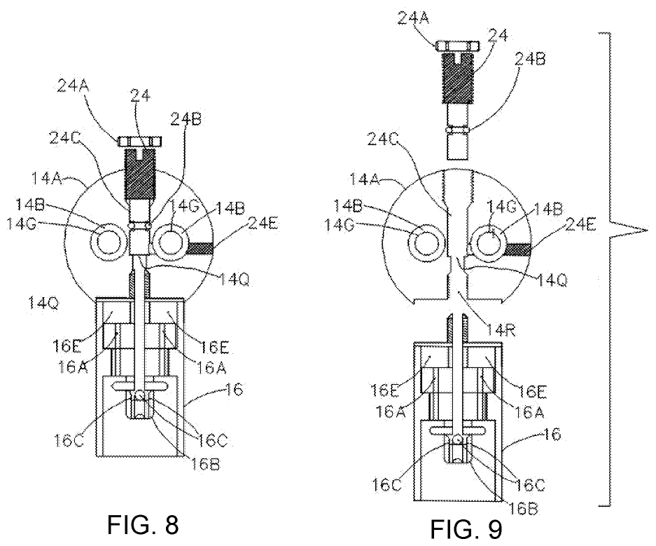

The second brixing screw 24 has a plurality of threads defined on an outer end of the second brixing screw 24 that engage with a corresponding plurality of threads defined at an outer end of the second brixing bore 24C. The second brixing screw 24 may be adjusted within the second brixing bore 24C by advancing or retracting the second brixing screw 24 within the second brixing bore 24C by cooperative engagement of the threads during rotation of the second brixing screw 24. The second brixing screw 24 may be secured in place by a locknut 24A. As best seen in reference to FIGS. 8 and 9, the second brixing bore 24C extends vertically between a lateral sidewall of the elongate cylindrical body 14A and the dispenser port 14Q. The second brixing bore 24C intersects with a lateral bore 24F extending from the second internal bore 14B′ to provide fluid communication between the second of the pair of internal bores 14B′ and the dispenser port 14Q. The lateral bore 24F is closed at the lateral sidewall by a plug 24E.

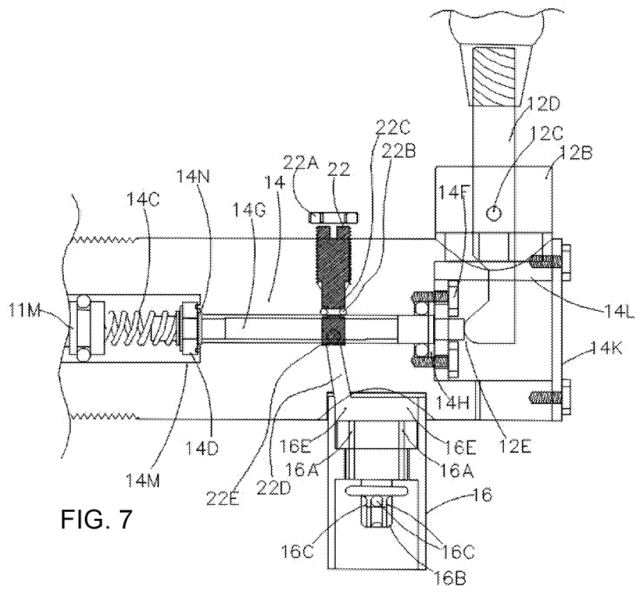

In the embodiment shown in FIGS. 10 and 11, the first fluid path may be fabricated by drilling a first lateral bore 22F that intersects with the first of the pair of internal bores 14B to define the first lateral bore 22F, such as seen in reference to FIGS. 7, 10 and 11. An outer aspect of the lateral bore may be filled with a plug 22E. The terminal fluid path 22D may be drilled from the orifice 22G receiving the nozzle and diffuser assembly 16 to intersect with the first lateral bore 22F. The terminal fluid path may be drilled at an angle oriented towards the proximal end of the elongate cylindrical body 14A to provide a longitudinal separation from a second brixing screw 24, as best seen in reference to FIG. 7.

The nozzle and diffuser assembly 16 provides a beverage syrup path and a water path between the respective internal bores 14B for delivery into the containment vessel 18. The nozzle and diffuser assembly 16 is formed a cylindrical cap that is coupled with the drafting head 14 via a dispenser port 14Q defined in a bottom surface of the drafting head 14 at the distal end of the internal bores 14B, 14B′. The nozzle and diffuser assembly 16 includes a diffuser 16A, a beverage syrup nozzle 16B, which may include a plurality of laterally oriented ejection apertures 16C for directing a lateral flow of the beverage syrup into a downward flow of the water from the diffuser 16A, and a gasket 16D.

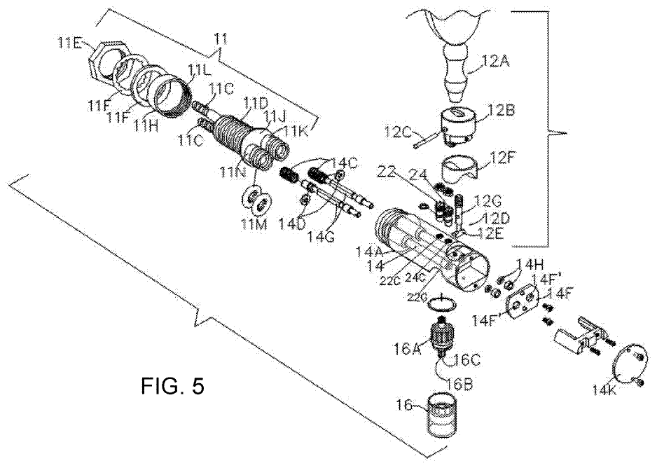

As best seen in reference to FIGS. 4 and 5, the beverage syrup nozzle 16B is received in a threaded bore 14R extending into the drafting head 14. To provide a coaxial alignment of the beverage syrup nozzle 16B and a longitudinal alignment of the nozzle and diffuser assembly 16, the threaded bore 14R is defined between each of the internal bores 14B, 14B′. The beverage syrup path is defined between the threaded bore 14R and the beverage syrup delivery bore 14B′.

The water path is provided by drilling a second hole 14U to interconnect the water delivery bore 14B with the with the dispenser port 14Q. In this case the water is delivered via the water delivery bore 14B and is received upstream of the diffuser 16A. As the water exits the diffuser 16A it is mixed with the beverage syrup as the two ingredients are dispensed into the containment vessel 18.

When the drafting head 14 is fabricated by conventional machining, the beverage syrup path may be defined by drilling a first hole 14S extending from an end of the threaded bore 14R and a third hole 14T extending from the beverage syrup delivery bore 14B′ and intersecting with the first hole 14S. Because the beverage syrup delivery bore 14B′ is contained within the elongate cylindrical body 14A, the third hole 14T will need to be drilled through a lateral sidewall of the elongate cylindrical body 14A. In this case, a plug 14J is used to seal the hole in the lateral sidewall of the elongate cylindrical body 14A to constrain the beverage syrup flow to the beverage syrup delivery path. As will be appreciated, the drafting head 14 may also be formed by an additive fabrication process, in this case, the internal passages for the beverage syrup path need only connect the beverage syrup delivery bore 14B′ with the beverage syrup nozzle 16B.

The present disclosure also includes a method of dispensing a post-mix beverage at a desired mixture ratio is disclosed. The method includes providing a post-mix beverage dispensing tap valve 10 having a drafting head 14 formed as an elongate cylindrical body having proximal end and a distal end. The elongate cylindrical body includes a first internal bore 14B for communicating the first liquid through the drafting head 14. A second internal bore 14B′ for communicating the second liquid through the drafting head 14 is also provided. A nozzle and diffuser assembly 16 is disposed at the distal end of the drafting head having a first liquid path in communication with the first internal bore 14B.

A second liquid path is defined in communication with the second internal bore 14B′. The beverage syrup nozzle 16B is configured to dispense the first liquid and the second liquid on activation of a tap actuator unit 12. The tap actuator unit 12 is operable to simultaneously operate a seal 14D carried on a piston shaft 14G in each of the first internal bore 14B and the second internal bore 14B′ to selectively open or close a flow in each of the first liquid path and the second liquid path.

A first brixing screw 22 is adjustably carried within a first brixing bore 22 C to selectively position a distal end of the first brixing screw 22 to at least partially obstruct the flow of the first fluid through the first fluid path. A second brixing screw 24 is adjustably carried within a second brixing bore 24C to selectively position a distal end of the second brixing screw 24 to at least partially obstruct flow of the second fluid through the second fluid path.

The method includes dispensing the first liquid through the nozzle and diffuser assembly 16 while blocking a flow of the second liquid trough the post-mix beverage dispensing tap valve 10. The dispensed first liquid is captured in a containment vessel 18. Preferably, the containment vessel 18 is graduated to provide indicia for determining a quantity of liquid carried in the containment vessel 18. A flow rate of the first liquid is determined based on a volume of the first liquid captured in the containment vessel 18 during a first temporal period. Accordingly, the method includes timing the dispensing of the first liquid into the containment vessel 18. Timing may be performed for a specified duration before shutting off flow of the first liquid. Alternatively, the timing may be performed while a specified volume of the first liquid is captured in the containment vessel 18.

The method may also include dispensing the second liquid through the nozzle and diffuser assembly 16 while blocking a flow of the first liquid through the post-mix beverage dispensing tap valve 10. The dispensed second liquid is similarly captured in the containment vessel 18. A flow rate of the second liquid is determined based on a volume of the second liquid captured in the containment vessel 18 during a second temporal period.

In certain embodiments, the method includes determining a present mixture ratio of the first liquid and the second liquid based on the flow rate of the first liquid and the flow rate of the second liquid. Likewise, rotating the first brixing screw 22 may be performed to vary the flow rate of the first liquid to obtain a desired mixture ratio based on the present mixture ratio. Once obtained, the method includes tightening a locknut 22A on the first brixing screw to secure the first brixing screw at the desired mixture ratio.

The method may also include rotating the second brixing screw 24 to vary the flow rate of the second liquid to obtain the desired mixture ratio based the present mixture ratio. Once the desired mixture ratio is attained, the method includes tightening a locknut 24A on the second brixing screw 24 to secure the first brixing screw at the desired mixture ratio.

It should be understood, of course, that the foregoing relates to exemplary embodiments of the invention and that modifications may be made without departing from the spirit and scope of the invention as set forth in the following claims.

I claim:

1. A post-mix dispensing tap valve for dispensing of a first liquid and a second liquid at a desired mixture ratio, comprising:
a tap head formed as an elongate cylindrical body having proximal end and a distal end, a first bore for communicating the first liquid through the tap head, a second bore for communicating the second liquid through the tap head;
a nozzle and diffuser assembly disposed at the distal end of the tap head having a first liquid path in communication with the first bore and a second liquid path in communication with the second bore, the nozzle configured to dispense the first liquid and the second liquid into a containment vessel positioned below the nozzle and diffuser assembly; and
a first brixing bore defined in the an outer sidewall of the elongate cylindrical body and intersecting the first liquid path;
a first brixing screw adjustably carried within the first brixing bore to selectively position a distal end of the first brixing screw to at least partially obstruct flow of the first liquid through the first liquid path;
a second brixing bore defined in the outer sidewall of the elongate cylindrical body and intersecting the second liquid path;
a second brixing screw adjustably carried within the second brixing bore to selectively position a distal end of the second brixing screw to at least partially obstruct flow of the second liquid through the second liquid path; and
wherein an adjustment of each of the first brixing screw and the second brixing screw set the desired mixture ratio of each of the first liquid and the second liquid.

2. The post-mix dispensing tap valve of claim 1, further comprising:
an O-ring carried on each of the first brixing screw and the second brixing screw, each O-ring providing a fluid tight seal between the outer sidewall of each of the first brixing bore and the second brixing bore and the corresponding first liquid path and the second liquid path.

3. The post-mix dispensing tap valve of claim 1, further comprising:
a plurality of threads defined on an outer end of each of the first brixing screw and the second brixing screw;
a corresponding plurality of threads defined in each of the first brixing bore and the second brixing bore; and
wherein rotation of each of the first brixing screw and the second brixing screw with are rotatably carried within its corresponding first brixing bore and second brixing bore to advance or withdraw each of the first brixing screw and the second brixing screw from its corresponding first flow path and second flow path.

4. The post-mix dispensing tap valve of claim 1, further comprising:
a locking nut threadingly carried on each of the first brixing screw and the second brixing screw and adapted to secure each of the first brixing screw and the second brixing screw at the desired mixture ratio.

5. The post-mix dispensing tap valve of claim 1, the first liquid path further comprising:
a first lateral bore extending between the first bore and a peripheral fluid path in communication with a diffuser surrounding the nozzle.

6. The post-mix dispensing tap valve of claim 5, wherein the first brixing screw is selectively positioned to at least partially obstruct the first lateral bore at the desired mixture ratio.

7. The post-mix dispensing tap valve of claim 5, the second liquid path further comprising:
a dispenser port interposed between the second bore and the nozzle.

8. The post-mix dispensing tap valve of claim 7, wherein the second brixing screw is selectively positioned to at least partially obstruct the dispenser port at the desired mixture ratio.

9. The post-mix dispensing tap valve of claim 5, further comprising a plug disposed in the second lateral bore proximal to the outer sidewall.

10. The post-mix dispensing tap valve of claim 5, further comprising:
a plug disposed in the second lateral bore proximal to the outer sidewall.

11. The post-mix dispensing tap valve of claim 1, further comprising:
a tap actuator unit selectively operates a piston shaft in each of the first bore and the second bore simultaneously operate a seal carried on each piston between a flow and no-flow condition.

12. The post-mix dispensing tap valve of claim 1, further comprising:
the nozzle and diffuser assembly removably coupled with the tap head via a threaded coupling with a dispenser port interposed between the second bore and the nozzle.

13. The post-mix dispensing tap valve of claim 1, the nozzle and diffuser assembly further comprising:
a peripheral fluid path surrounding the nozzle.

14. A method of dispensing a post-mix beverage at a desired mixture ratio, comprising:
providing a post-mix dispensing tap valve having a head formed as an elongate cylindrical body having proximal end and a distal end, a first bore for communicating a first liquid through the head, a second bore for communicating a second liquid through the head; a nozzle and diffuser assembly disposed at the distal end of the head having a first liquid path in communication with the first bore, a second liquid path in communication with the second bore, the nozzle configured to dispense the first liquid and the second liquid on activation of a tap actuator unit operable to simultaneously operate a valve in each of the first bore and the second bore to selectively open or close a flow in each of the first liquid path and the second liquid path, a first brixing screw adjustably carried within a first brixing bore to selectively position a distal end of the first brixing screw to at least partially obstruct the flow of the first liquid through the first liquid path, and a second brixing screw adjustably carried within a second brixing bore to selectively position a distal end of the second brixing screw to at least partially obstruct flow of the second liquid through the second liquid path;
dispensing the first liquid through the nozzle and diffuser assembly while blocking a flow of the second liquid trough the post-mix dispensing tap valve;
capturing the dispensed first liquid in a containment vessel; and
determining a flow rate of the first liquid based on a volume of the first liquid captured in the containment vessel during a first temporal period.

15. The method of claim 14, further comprising:
dispensing the second liquid through the nozzle and diffuser assembly while blocking a flow of the first liquid through the post-mix dispensing tap valve;
capturing the dispensed second liquid in the containment vessel; and
determining a flow rate of the second liquid based on a volume of the second liquid captured in the containment vessel during a second temporal period.

16. The method of claim 15, further comprising:
determining a present mixture ratio of the first liquid and the second liquid based on the flow rate of the first liquid and the flow rate of the second liquid.

17. The method of claim 16, further comprising:
rotating the first brixing screw to vary the flow rate of the first liquid to obtain a desired mixture ratio based on the present mixture ratio.

18. The method of claim 17, further comprising:
tightening a locknut on the first brixing screw to secure the first brixing screw at the desired mixture ratio.

19. The method of claim 16, further comprising:
rotating the second brixing screw to vary the flow rate of the second liquid to obtain a desired mixture ratio based the present mixture ratio.

20. The method of claim 17, further comprising:
tightening a locknut on the second brixing screw to secure the second brixing screw at the desired mixture ratio.
